(19) United States
(12) Patent Application Publication
(10) Pub. No.: US 2019/0121425 A1
(43) Pub. Date: Apr. 25, 2019

(54) CHAIR-TYPE VIRTUAL REALITY CONTROLLER

(71) Applicant: ATTICFAB CO., LTD., Seoul (KR)

(72) Inventors: Sang Hyuk LEE, Hanam-si (KR); Jae Hyun WOO, Seoul (KR); Ki Seob KIM, Seoul (KR); Sang Deok LEE, Hanam-si (KR)

(73) Assignee: ATTICFAB CO., LTD., Seoul (KR)

(21) Appl. No.: 16/210,881

(22) Filed: Dec. 5, 2018

Related U.S. Application Data
(63) Continuation of application No. PCT/KR2017/007563, filed on Jul. 14, 2017.

(30) Foreign Application Priority Data
Jul. 29, 2016 (KR) 10-2016-0096646
Feb. 16, 2017 (KR) 10-2017-0020882
Mar. 21, 2017 (KR) 10-2017-0035208

(51) Int. Cl. G06F 3/01; A47C 1/00; A47C 3/18; A47C 7/00; A47C 7/02; A63F 13/98; G01L 1/20

(52) U.S. Cl. CPC G06F 3/011; A47C 1/00; A47C 3/18; G06T 7/20; A47C 7/029; A63F 13/98; G01L 1/205; A47C 7/004

(57) ABSTRACT

The inventive concept relates to a chair-type virtual reality controller, wherein the chair-type virtual reality controller includes a seat on which a user is seated, a base on which feet of the user seated on the seat rest, wherein a walking motion of the user is performed on the base; a rotary shaft rotatably coupled to the base such that the seat rotates relative to the base; and a control unit configured to present a VR image to the user based on a rotation motion of a body of the user seated on the seat around the rotary shaft and the walking motion of the user on the base.

### CROSS-REFERENCE TO RELATED APPLICATIONS

The present application is a continuation of International Patent Application No. PCT/KR2017/007563, filed on Jul. 14, 2017, which is based upon and claims the benefit of priority to Korean Patent Application Nos. 10-2016-0096646 filed on Jul. 29, 2016, 10-2017-0020882 filed on Feb. 16, 2017 and 10-2017-0035208 filed on Mar. 21, 2017. The disclosures of the above-listed applications are hereby incorporated by reference herein in their entirety.

### BACKGROUND

Embodiments of the inventive concept relate to a chair-type virtual reality controller, and more particularly, relate to a virtual reality controller having a chair shape.

In recent years, Virtual Reality (VR) has been recognized as a key technology for the future, providing a 360-degree 3-dimensional virtual experience that is immersive to a user via goggles or a Head Mounted Display (HMD). However, in order to provide a stable experience environment, it is necessary to develop additional peripheral product and technology.

Therefore, a device for experiencing the VR has been widely spread. However, the conventional VR experience device has problems that an unnatural space movement occurs and a lot of space is required.

Accordingly, the present applicant has come to develop a chair-type virtual reality controller that overcomes the unnatural space movement, and a limited space utilization manner of a room scale VR. The chair-type virtual reality controller may also allow the user to move naturally in an infinite space in a VR content, and reduce a physical burden by sharing a weight of the user to provide a comfortable use environment to the user for experiencing the VR for a long time.

### SUMMARY

Embodiments of the inventive concept provide a chair-type virtual reality controller that allows a user to sit on a seat stably, and to take a posture in which feet of the user rest on a base, thereby reducing a user's exhaustion of physical strength, and allowing the user to experience a VR content in a comfortable and immersive way based on a user's walking motion.

According to an aspect of an embodiment, a chair-type virtual reality controller includes a seat on which a user sits, a base on which feet of the user seated on the seat rest, wherein a walking motion of the user is performed on the base, a rotary shaft rotatably coupled to the base such that the seat rotates relative to the base, and a control unit configured to present a VR image to the user based on a rotation motion of a body of the user seated on the seat around the rotary shaft and the walking motion of the user on the base.

According to another aspect of an embodiment, a center axis of the rotary shaft is coaxial with a line of gravity of the user seated on the seat.

According to another aspect of an embodiment, the chair-type virtual reality controller further includes a sensing unit provided at the base for sensing a movement of the feet resting on the base, wherein the control unit is further configured to convert movement data of the feet sensed by the sensing unit into data available in a VR content, and then to provide the VR image to the user.

According to an aspect of an embodiment, the sensing unit includes a laser emitter for emitting a laser to the feet of the user resting on the base, a two-dimensional infrared camera for tracking an image formed on the feet of the user by the laser, and a sensor control board for generating the movement data of the feet by analyzing the image captured by the two-dimensional infrared camera, and for transmitting the movement data of the feet via a communication module to the control unit.

According to another aspect of an embodiment, the sensing unit includes an electro-conductive resistive sensor for recognizing a coordinate value based on the movement of the user's feet resting on the base.

According to another aspect of an embodiment, the sensing unit includes a pressure-sensitive sensor film for recognizing a weight or a touch based on the movement of the user's feet resting on the base.

According to an aspect of an embodiment, the sensing unit includes an X-axis sensing pattern module including a plurality of pressure-sensitive electro-conductive lines arranged in an X-axis, wherein X-axis sensing pattern module is configured to sense a pressed X-axis position on a weight sensing plate, and a Y-axis sensing pattern module disposed in contact with a bottom face of the X-axis sensing pattern module, wherein the Y-axis sensing pattern module includes a plurality of pressure-sensitive electro-conductive lines arranged in a Y-axis and is configured to sense a pressed Y-axis position on the weight sensing plate.

According to another aspect of an embodiment, the X-axis sensing pattern module includes an X-axis pressure-sensitive electro-conductive film, wherein a current flows in a region of the X-axis pressure-sensitive electro-conductive film where a pressure is sensed, an upper X-axis sensing film having a pattern of a plurality of 1-1 electro-conductive lines parallelly arranged in the X-axis, wherein the upper X-axis sensing film is disposed on a top face of the X-axis pressure-sensitive electrode-conductive film, and a lower X-axis sensing film having a pattern of a plurality of 1-2 electro-conductive lines parallelly arranged in the X-axis to correspond to the 1-1 electro-conductive lines, wherein the lower X-axis sensing film is disposed on a bottom face of the X-axis pressure-sensitive electrode-conductive film.

According to another aspect of an embodiment, the Y-axis sensing pattern module includes a Y-axis pressure-sensitive electro-conductive film, wherein a current flows in a region of the Y-axis pressure-sensitive electro-conductive film where a pressure is sensed; an upper Y-axis sensing film having a pattern of a plurality of 2-1 electro-conductive lines parallelly arranged in the Y-axis, wherein the upper Y-axis sensing film is disposed on a top face of the Y-axis pressure-sensitive electrode-conductive film; and a lower Y-axis sensing film having a plurality of 2-2 electro-conductive lines parallelly arranged in the Y-axis to correspond to the 2-1 electro-conductive lines, wherein the lower Y-axis sensing film is disposed on a bottom face of the Y-axis pressure-sensitive electrode-conductive film.

According to an aspect of an embodiment, the seat includes a buttocks support for supporting user's buttocks and waist, an abdomen support for supporting a user's abdomen, and a connection passing between user's legs, wherein the connection connects the butts support and the abdomen support.

According to another aspect of an embodiment, the seat further includes a backrest for supporting a back of the user sitting on the seat.

According to another aspect of an embodiment, the abdomen support further includes a cushion for providing comfort, wherein the cushion is provided in a region of the abdomen support facing the user's abdomen.

According to an aspect of an embodiment, the chair-type virtual reality controller further includes a height adjuster provided at the base or the rotary shaft for adjusting a height of the seat relative to the base.

According to the inventive concept, the user may sit on the seat stably, and take the posture in which the feet of the user rest on the base such that the user's exhaustion of physical strength may be reduced, and the user may experience the VR content in the comfortable and immersive way based on the walking motion of the user.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 shows a front view of a chair-type virtual reality controller according to an embodiment of the inventive concept,

FIG. 2 shows a side view of FIG. 1,

FIG. 3 shows a rear view of FIG. 1,

FIG. 4 shows a control block diagram of a chair-type virtual reality controller according to an embodiment of the inventive concept,

FIG. 5 is an operation conceptual side view of a sensing unit according to an embodiment of the inventive concept,

FIG. 6 is an operation conceptual top view of a sensing unit according to an embodiment of the inventive concept,

FIG. 7 is a structure diagram of a sensing unit according to another embodiment of the inventive concept,

FIG. 8 is a structure diagram of a sensing unit according to another embodiment of the inventive concept, and

FIG. 9 is a conceptual diagram showing that an X-axis position and a Y-axis position are sensed by a sensing unit of FIG. 8, and transmitted to an input control unit.

### DETAILED DESCRIPTION

Advantages and features of the inventive concept, and a method for accomplishing them will become apparent from the following description of the following embodiments given in conjunction with the accompanying drawings. However, the inventive concept is not limited to the embodiments disclosed below, but may be implemented in various forms. The embodiments of the inventive concept are only provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. The same reference numerals denote like components throughout the specification, “and/or” includes each and every combination of one or more of the components mentioned. Unless otherwise defined, all terms (including technical and scientific terms) used herein have the same meaning as commonly understood by those skilled in the art to which the inventive concept pertains. It will be further understood that terms, such as those defined in commonly used dictionaries should not be interpreted in an idealized or overly formal sense unless expressly so defined herein.

Hereinafter, the inventive concept will be described in detail with reference to the accompanying drawings.

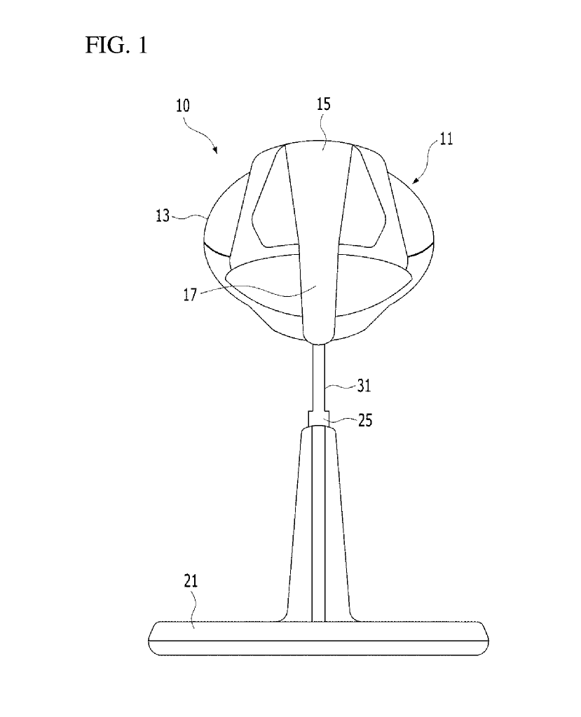

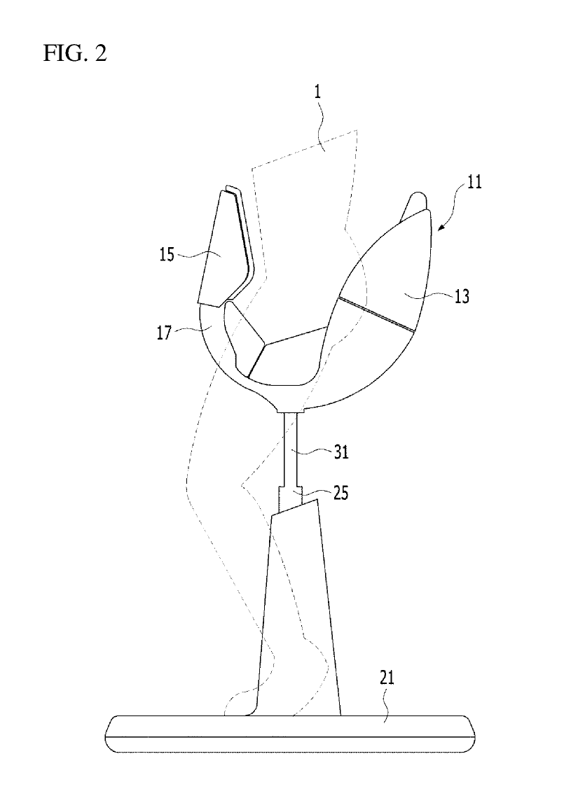

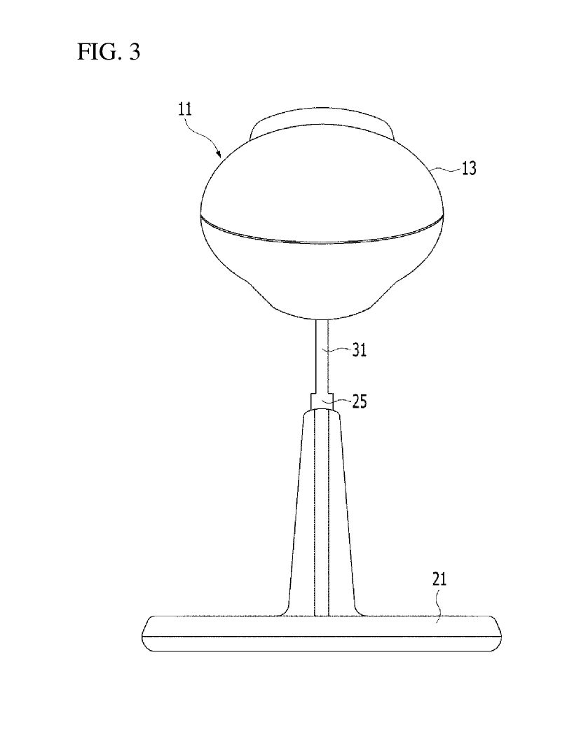

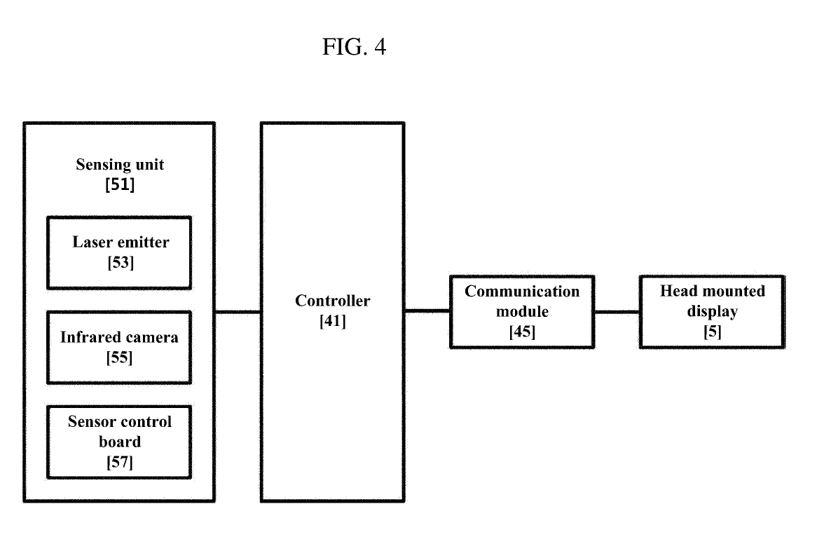

FIG. 1 to FIG. 4 show a chair-type virtual reality controller according to an embodiment of the inventive concept.

As shown in these figures, a chair-type virtual reality controller 10 according to an embodiment of the inventive concept includes a seat 11 on which a user 1 sits, a base 21, a rotary shaft 31, and a control unit 41.

The seat 11 includes a buttocks support 13 for supporting buttocks and a waist of a user 1, an abdomen support 15 for supporting an abdomen of the user 1, and a connection 17 that passes between legs of the user 1, and connects the butts support 13 and the abdomen support 15.

The buttocks support 13 preferably has a shape tilted rearwardly of the user 1 so as to support the buttocks and the waist of the user 1. Thus, a weight of the user 1 may be shared while maintaining a standing posture when the user 1 is sitting on the seat 11.

When the user 1 performs a walking motion while sitting on the seat 11, the abdomen support 15 supports a forward-inclining body of the user 1. In addition, although not shown, the abdomen support 15 may further include a cushion for providing comfort, wherein the cushion is provided in a region of the abdomen support facing the user's abdomen. In addition, the abdomen support 15 may support arms of the user 1 seated on the seat 11.

The connection 17 does not interfere with the legs of the user 1, and has a size such that a distance between the legs does not spread unnaturally.

Thus, the chair-type virtual reality controller 10 according to an embodiment of the inventive concept defines free space at left and right sides of the connection 17. Therefore, both thighs of the user 1 are exposed to the outside. This allows the user 1 to perform the walking motion even when the user 1 is seated on the seat 11. Further, through this, the user may easily sit on the seat 11 through the connection.

In addition, the seat 11 may further include a backrest supporting a back of the user 1 seated on the seat 11.

In this way, the backrest is prepared such that the user 1 may be protected from falling rearward when the user 1 is surprised during a VR content execution, or walks rearward.

The base 21 has a plate-shape, wherein the feet of the user 1 seated on the seat 11 rest on the base 21. In addition, the walking motion of the user 1 is performed on the base 21. The base 21 is preferably made of a material having a low frictional force such that the feet of the user 1 may naturally slide thereon.

The rotary shaft 31 is rotatably coupled to the base 21 such that the seat 11 rotates relative to the base 21.

A center axis of the rotary shaft 31 is preferably coaxial with a line of gravity of the user 1 seated on the seat 11. Because of this, when the seat 11 is rotated, the user 1 may feel centrifugal force based on the rotation of the seat 11 to the minimum.

In one example, the rotary shaft 31 is provided with a height adjuster 25 for adjusting a height of the seat 11 relative to the base 21. A shock absorber, or the like may be provided as the height adjuster 25.

As such, the height of the seat 11 is adjusted by the height adjuster 25 such that not only the user 1 may easily sit on the seat 11, but also the seat 11 may be used corresponding to various heights of the user 1.

In this connection, the height adjuster 25 is shown as being provided on the rotary shaft 31 in this embodiment, but a position of the height adjuster 25 is not limited thereto. The height adjuster 25 may be provided on the base 21.

The control unit 41 calculates feet position data based on a rotation motion of a body of the user 1 seated on the seat 11 around the rotary shaft 31 and the walking motion of the user 1 on the base 21. For example, the control unit 41 calculates the feet position in real time to generate a movement of a character or to calculate a movement distance in a computing device (e.g., a PC, a server device, a mobile device, and the like).

Further, the control unit 41 calculates a center point within a range of each foot obtained by a sensing unit 51 described below, in order to calculate a correct foot motion. The control unit 41 calculates the center point of the foot having an area, and generates data for applying the position movement of the center point of each foot to a position movement of the foot in a virtual space (or the movement of the character). The control unit 41 generates data about the position movement of the center point, and transmits the generated data to the computing device through wired or wireless communication.

This control unit 41 may be provided at one side of the base 21 of the chair-type virtual reality controller 10. The control unit 41 may be connected to the sensing unit 51 described below to receive an image obtained by a camera so that the calculation of the feet position may be performed.

In another embodiment, the control unit 41 may be included in a separate computing device (e.g., a PC, a server computer, or a mobile device) electrically connected to goggles or a Head Mounted Display 5, or may be included in goggles or the Head Mounted Display 5 (that is, All-in-One Head Mounted Display; All-in-One HMD) where the computing device is combined. In this case, the chair-type virtual reality controller 10 may transmit image data (that is, sensing data) itself obtained from an infrared camera 55 to the external computing device through the wired or wireless communication. In addition, the computing device may calculate the feet position in real time.

Further, in another embodiment, when the control unit 41 is provided with the chair-type virtual reality controller 10, the control unit 41 includes a communication module 45. The communication module 45 transmits the feet position data (that is, movement data of the feet generated by analyzing the image taken by the infrared camera 55) generated by the control unit to the computing device through the wired or wireless communication. When transmitting the feet position data (or the feet movement data) through the wireless communication, the communication module 45 may include a wireless communication module for using Wi-Fi, or the like.

Further, the chair-type virtual reality controller 10 according to an embodiment of the inventive concept further includes the sensing unit 51 for sensing the movement of the feet resting on the base 21. Various methods for obtaining the feet position on the base 21 may be applied to the sensing unit 51.

In one embodiment, an infrared image sensing method may be applied to the sensing unit 51. This infrared image sensing type sensing unit 51 includes a laser emitter 53, which emits a laser to the feet of the user 1 resting on the base 21, and the infrared camera 55 (e.g., a two-dimensional infrared camera) that tracks an image formed on the feet of the user 1 by the laser. Further, in another embodiment, the sensing unit 51 may further include a sensor control board 57 for transmitting a captured image to the control unit 41.

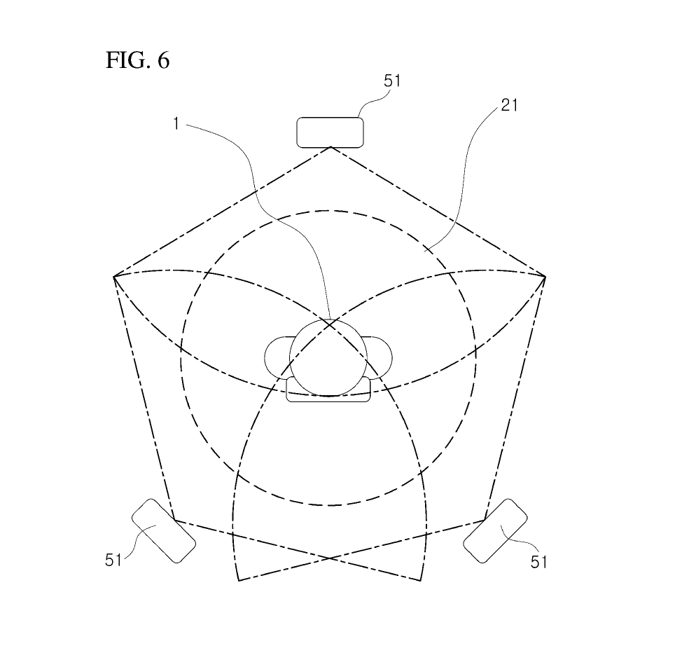

In one embodiment, the chair-type virtual reality controller 10 may include a plurality of sensing units (e.g., a combination of the laser emitter 53 and the infrared camera 55). That is, the plurality of sensing units 51 may be arranged at different positions of the base 21. For example, when the chair-type virtual reality controller 10 includes two sensing units 51, the sensing units 51 may be arranged at positions perpendicular to each other. Further, in another embodiment, as shown in FIG. 6, the chair-type virtual reality controller 10 may include three sensing units 51. The three sensing units 51 may be arranged at regular intervals along a circumference of the base 2, and may combine the data acquired from each of the sensing units 51 to calculate the movement of the feet (for example, the sensing units 51 may be disposed at an angular interval of 120 degree with respect to a center of the base 21). That is, each of the sensing units 51 may acquire the data about the movement of the feet of the user 1 within a coverage range of each. In this connection, in another embodiment, the sensing unit 51 may include a pair of sensing units, or four or more sensing units.

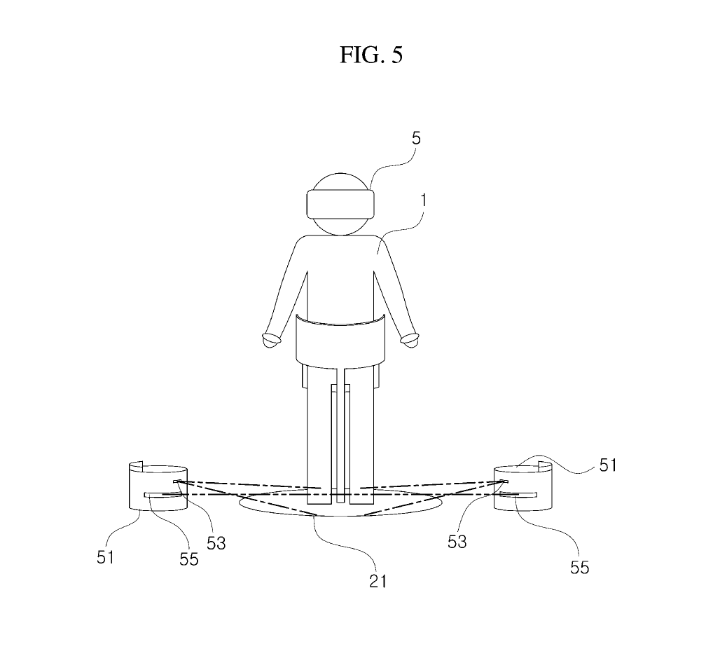

For example, as shown in FIG. 5 and FIG. 6, when the laser emitted from the laser emitter 53 located at a height of, for example, 5 to 10 mm from the base 21 is incident on the feet of the user 1, the image captured by the two-dimensional infrared camera 55 located below the laser emitter 53 is analyzed by the sensor control board 57 to generate the movement data of the feet of the user 1. Then, the movement data generated by the sensor control board 57 is transmitted to the control unit 41. The control unit 41 integrates the movement data transmitted from the sensor control boards 57 to reconstruct the movement data into a single spatial coordinate, and calculates the center point of the feet. Then, the control unit 41 converts the analyzed movement data of the user's feet into a movement command on the integrated spatial coordinate to generate data usable in the VR content.

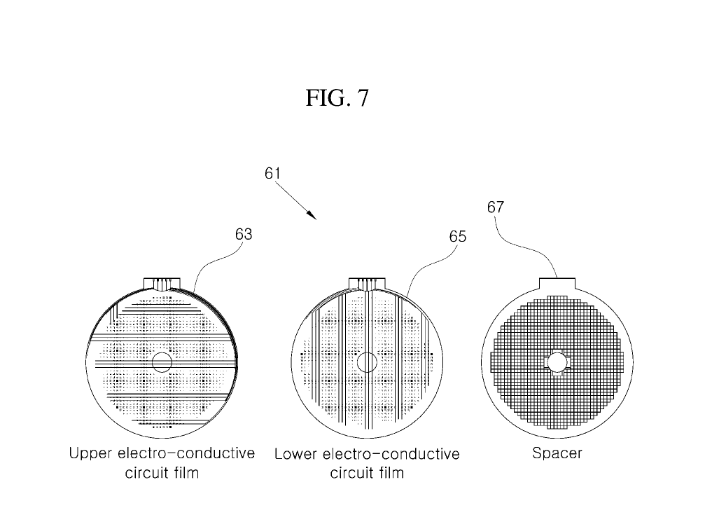

In another embodiment, the sensing unit 61 may include an electro-conductive resistive sensor provided at the base 21, wherein the electro-conductive resistive sensor recognizes a coordinate value based on the movement of the feet of the user 1 rested on the base 21. As shown in FIG. 7, the electro-conductive resistive sensor includes an upper electro-conductive circuit film 63, a lower electro-conductive circuit film 65, and a spacer 67 interposed between the upper electro-conductive circuit film 63 and the lower electro-conductive circuit film 65.

For example, the coordinate values are assigned to each row and column of each electro-conductive circuit film, and the movement of the feet of the user 1 is recognized as the coordinate value. Then, the coordinate value data generated from the electro-conductive resistive sensor is transmitted to the control unit 41 via the communication module 45. The control unit 41 converts the coordinate value data transmitted from the electro-conductive resistive sensor into the movement command on the spatial coordinate, and generates the data usable in the VR content.

In another embodiment, a sensing unit 71 may include a pressure-sensitive sensor film provided at the base 21, wherein the pressure-sensitive sensor recognizes a weight or a touch based on the movement of the feet due to the walking motion of the user 1 resting on the base 21.

The sensing unit 71 according to another embodiment of the inventive concept is provided inside the base 21 to sense an X-axis position and a Y-axis position at which the pressure pressed on the base 21 is sensed. When the feet of user 1 touches the base 21 such that the weight is delivered, the sensing unit 71 senses the weight where the feet of the user 1 is touched and thus senses an X-axis position and a Y-axis position where is the sensing area of the base 21.

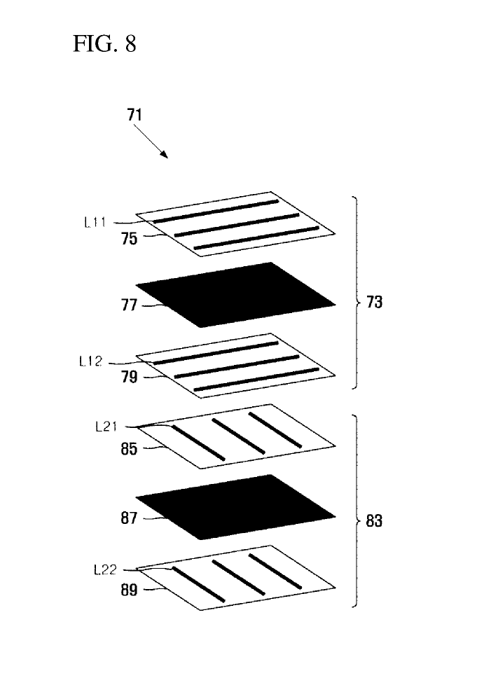

To this end, various sensor means for sensing the X-axis position and the Y-axis position at which the pressure is sensed may be used as the sensing unit 71. As shown in FIG. 8, the sensing unit 71 is provided with an X-axis sensing pattern module 73 and a Y-axis sensing pattern module 83.

The X-axis sensing pattern module 73 includes a plurality of electro-conductive lines L11 and L12 arranged in the X-axis, and senses the pressed X-axis position on the base 21. In order to sense the X-axis position accurately, the X-axis sensing pattern module 73 includes an X-axis pressure-sensitive electro-conductive film 77, wherein a current flows in a region of the X-axis pressure-sensitive electro-conductive film where a pressure is sensed, an X-axis sensing film 75 having a pattern of a plurality of 1-1 electro-conductive lines L11 parallelly arranged in the X-axis, wherein the X-axis sensing film 75 is disposed on a top face of the X-axis pressure-sensitive electrode-conductive film 77 (hereinafter, referred to as an ‘upper X-axis sensing film’), and an X-axis sensing film 79 having a pattern of a plurality of 1-2 electro-conductive lines L12 parallelly arranged in the X-axis to correspond to the 1-1 electro-conductive lines L11, wherein the X-axis sensing film 79 is disposed on a bottom face of the X-axis pressure-sensitive electro-conductive film 77 (hereinafter, referred to as a ‘lower X-axis sensing film’).

The X-axis pressure-sensitive electro-conductive film 77 may be embodied as a pressure-sensitive electro-conductive film such as Velostat, and the like, which is a material that, the current flows in a region thereof where the pressure is sensed.

In addition, the upper X-axis sensing film 75 and the lower X-axis sensing film 79 correspond to each other, and are positioned above and below the X-axis pressure-sensitive electro-conductive film 77, respectively. In this connection, the 1-1 electro-conductive lines L11 patterned on a bottom face of the upper X-axis sensing film 75 and the 1-2 electro-conductive lines L12 patterned on a top face of the lower X-axis sensing film 79 correspond to each other, and arranged at the same position.

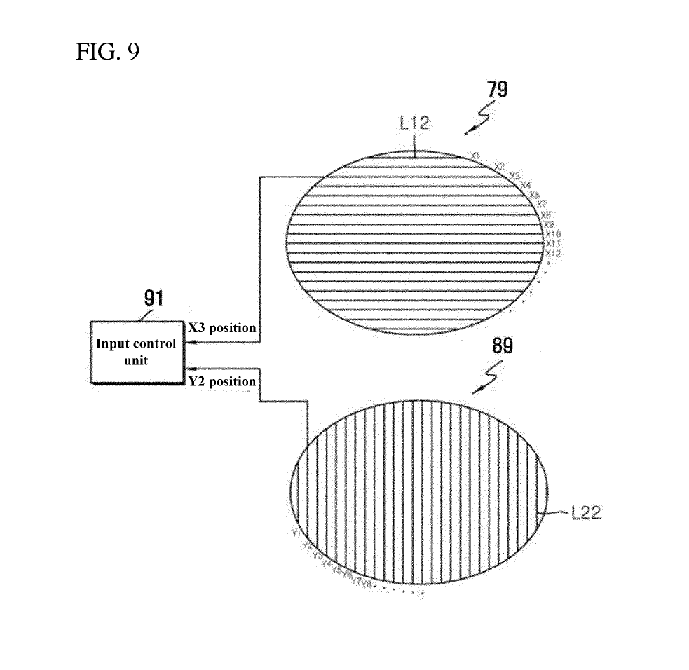

Thus, as shown in FIG. 8, the pressure transmitted through the 1-1 electro-conductive lines L11 of the upper X-axis sensing film 75 bonded to the top face of the X-axis pressure-sensitive electro-conductive film 77 is transferred to the X-axis pressure-sensitive electro-conductive film 77. As a result, the current flows in the region of the X-axis pressure-sensitive electro-conductive film 77 to which the pressure is transferred. Then, this current is transferred to the 1-2 electro-conductive lines L12 of the lower X-axis sensing film 79 bonded to the bottom face of the X-axis pressure-sensitive electro-conductive film 77. Thus, as shown in FIG. 9, the current flows on the 1-2 electro-conductive lines L12 of the lower X-axis sensing film 79, and a signal is transmitted to an input control unit 91.

In one example, the Y-axis sensing pattern module 83 includes a plurality of electro-conductive lines arranged in the Y-axis to sense the pressed Y-axis position on the base 21. In order to sense the Y-axis position accurately, the Y-axis sensing pattern module 83 includes a Y-axis pressure-sensitive electro-conductive film 87, wherein a current flows in a region of the Y-axis pressure-sensitive electro-conductive film where a pressure is sensed, a Y-axis sensing film 85 having a pattern of a plurality of 2-1 electro-conductive lines L21 parallelly arranged in the Y-axis, wherein the Y-axis sensing film 85 is disposed on a top face of the Y-axis pressure-sensitive electrode-conductive film 87 (hereinafter, referred to as an ‘upper Y-axis sensing film’), and an Y-axis sensing film 89 having a plurality of 2-2 electro-conductive lines L22 parallelly arranged in the Y-axis to correspond to the 2-1 electro-conductive lines L21, wherein the Y-axis sensing film 89 is disposed on a bottom face of the Y-axis pressure-sensitive electro-conductive film 87 (hereinafter, referred to as a ‘lower Y-axis sensing film’).

The Y-axis pressure-sensitive electro-conductive film 87 may be embodied as a pressure-sensitive electro-conductive film such as Velostat, and the like, which is a material that, the current flows in a region thereof where the pressure is sensed.

In addition, the upper Y-axis sensing film 85 and the lower face Y-axis sensing film 89 correspond to each other, and are positioned above and below the Y-axis pressure-sensitive electro-conductive film 87, respectively. In this connection, the 2-1 electro-conductive lines L21 patterned on the upper Y-axis sensing film 85 and the 2-2 electro-conductive lines L22 patterned on the lower Y-axis sensing film 89 correspond to each other, and arranged at the same position.

Thus, as shown in FIG. 8, the pressure transmitted through the 2-1 electro-conductive lines L21 of the upper Y-axis sensing film 85 bonded to the top face of the Y-axis pressure-sensitive electro-conductive film 87 is transferred to the Y-axis pressure-sensitive electro-conductive film 87. As a result, the current flows in the region of the Y-axis pressure-sensitive electro-conductive film 87 to which the pressure is transferred. Then, this current is transferred to the 2-2 electro-conductive lines L22 of the lower Y-axis sensing film 89 bonded to the bottom face of the Y-axis pressure-sensitive electro-conductive film 87. Thus, as shown in FIG. 9, the current flows on the 2-2 electro-conductive lines L22 of the lower Y-axis sensing film 89, and the signal is transmitted to the input control unit 91.

The input control unit 91 calculates the position of the user's feet placed on the base 21 using the X-axis position and the Y-axis position received from the sensing unit 71. Then, the calculated user's feet position is transmitted to the control unit 41 via the communication module 45.

For example, as shown in FIG. 9, when the current signal is recognized from a third X-axis line X3 on the lower X-axis sensing film 79 and the current signal is recognized from a second Y-axis line Y2 on the Y-axis sensing film, a sensing position of [x,y]=[3,2] may be grasped. The X-axis position and Y-axis position thus sensed are generated as the feet position data (or feet movement data), and may be transmitted to the computing device for generating a virtual reality (VR) image and utilized in a VR game.

In one example, this sensing unit 71 may be implemented to receive not only the user's feet position but also the weight pressure together. In the virtual reality (VR) game, not only the space movement of the user 1 but also a weight pressure value may be used for fun of the game.

To this end, the sensing unit 71 senses the weight pressure value on the X-axis and a weight pressure value on the Y-axis of the feet of the user 1 pressed on the base 21. Then, the sensing unit 71 transmits the weight pressure value on the X-axis and the weight pressure value on the Y-axis to the input control unit 91. In this connection, the term “weight pressure value” refers to an intensity of the currents that flow on the 1-2 electro-conductive lines L12 of the lower X-axis sensing film 79, and the 2-2 electro-conductive lines L22 of the lower Y-axis sensing film 89, respectively. This is because the more pressure is applied to the pressure-sensitive electro-conductive film, the more current flows.

Therefore, the input control unit 91 may calculate the weight pressure value by summing the weight pressure value on the X-axis and the weight pressure value on the Y-axis depending on the position of the feet of the user 1 placed on the base 21. That is, the intensity of the current transmitted from the lower X-axis sensing film 79 and the intensity of the current transmitted from the lower Y-axis sensing film 89 may be summed up. Then, the weight pressure value previously allocated to the current intensity may be extracted depending on the summed current intensity value.

In accordance with this configuration, when the user 1 sits stably with supporting the buttocks and the abdomen on the seat 11, takes the standing posture with the feet resting on the base 21, and intuitively performs the walking motion on the base 21 like a walking motion in the real world while the user 1 is wearing the Head Mounted Display 5 on which the VR image is displayed, the chair-type virtual reality controller 10 according to an embodiment of the inventive concept may recognize the walking motion, and implement the motion into a spatial movement in the VR content.

Thus, the user 1's exhaustion of physical strength may be reduced, and the user 1 may experience the VR content in the comfortable and immersive way based on their walking motion.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A chair-type virtual reality (VR) controller comprising:
a seat on which a user sits;
a base on which feet of the user seated on the seat rest, wherein a walking motion of the user is performed on the base;
a rotary shaft rotatably coupled to the base such that the seat rotates relative to the base; and
a control unit configured to present a VR image to the user based on a rotation motion of a body of the user seated on the seat around the rotary shaft and the walking motion of the user on the base.

2. The chair-type virtual reality controller of claim 1, wherein a center axis of the rotary shaft is coaxial with a line of gravity of the user seated on the seat.

3. The chair-type virtual reality controller of claim 1, further comprising a sensing unit provided at the base for sensing a movement of the feet resting on the base,
wherein the control unit is further configured to convert movement data of the feet sensed by the sensing unit into data available in a VR content, and then to provide the VR image to the user.

4. The chair-type virtual reality controller of claim 3, wherein the sensing unit includes:
a laser emitter for emitting a laser to the feet of the user resting on the base;
a two-dimensional infrared camera for tracking an image formed on the feet of the user by the laser; and
a sensor control board for generating the movement data of the feet by analyzing the image captured by the two-dimensional infrared camera, and for transmitting the movement data of the feet via a communication module to the control unit.

5. The chair-type virtual reality controller of claim 3, wherein the sensing unit includes an electro-conductive resistive sensor for recognizing a coordinate value based on the movement of the user's feet resting on the base.

6. The chair-type virtual reality controller of claim 3, wherein the sensing unit includes a pressure-sensitive sensor film for recognizing a weight or a touch based on the movement of the user's feet resting on the base.

7. The chair-type virtual reality controller of claim 3, wherein the sensing unit includes:
an X-axis sensing pattern module including a plurality of pressure-sensitive electro-conductive lines arranged in an X-axis, wherein X-axis sensing pattern module is configured to sense a pressed X-axis position on a weight sensing plate; and
a Y-axis sensing pattern module disposed in contact with a bottom face of the X-axis sensing pattern module, wherein the Y-axis sensing pattern module includes a plurality of pressure-sensitive electro-conductive lines arranged in a Y-axis and is configured to sense a pressed Y-axis position on the weight sensing plate.

8. The chair-type virtual reality controller of claim 7, wherein the X-axis sensing pattern module includes:
an X-axis pressure-sensitive electro-conductive film, wherein a current flows in a region of the X-axis pressure-sensitive electro-conductive film where a pressure is sensed;
an upper X-axis sensing film having a pattern of a plurality of 1-1 electro-conductive lines parallelly arranged in the X-axis, wherein the upper X-axis sensing film is disposed on a top face of the X-axis pressure-sensitive electrode-conductive film; and
a lower X-axis sensing film having a pattern of a plurality of 1-2 electro-conductive lines parallelly arranged in the X-axis to correspond to the 1-1 electro-conductive lines, wherein the lower X-axis sensing film is disposed on a bottom face of the X-axis pressure-sensitive electrode-conductive film.

9. The chair-type virtual reality controller of claim 1, wherein the Y-axis sensing pattern module includes:
a Y-axis pressure-sensitive electro-conductive film, wherein a current flows in a region of the Y-axis pressure-sensitive electro-conductive film where a pressure is sensed;
an upper Y-axis sensing film having a pattern of a plurality of 2-1 electro-conductive lines parallelly arranged in the Y-axis, wherein the upper Y-axis sensing film is disposed on a top face of the Y-axis pressure-sensitive electrode-conductive film; and
a lower Y-axis sensing film having a plurality of 2-2 electro-conductive lines parallelly arranged in the Y-axis to correspond to the 2-1 electro-conductive lines, wherein the lower Y-axis sensing film is disposed on a bottom face of the Y-axis pressure-sensitive electrode-conductive film.

10. The chair-type virtual reality controller of claim 1, wherein the seat includes:
a buttocks support for supporting user's buttocks and waist;
an abdomen support for supporting a user's abdomen; and
a connection passing between user's legs, wherein the connection connects the butts support and the abdomen support.

11. The chair-type virtual reality controller of claim 10, wherein the seat further includes a backrest for supporting a back of the user sitting on the seat.

12. The chair-type virtual reality controller of claim 10, wherein the abdomen support further includes a cushion for providing comfort, wherein the cushion is provided in a region of the abdomen support facing the user's abdomen.

13. The chair-type virtual reality controller of claim 1, further comprising a height adjuster provided at the base or the rotary shaft for adjusting a height of the seat relative to the base.
